(19) United States
(12) Patent Application Publication
(10) Pub. No.: US 2025/0108381 A1
(43) Pub. Date: Apr. 3, 2025

(54) DIGITAL MICROFLUIDICS SYSTEM, INSTRUMENT, AND CARTRIDGE ASSEMBLY INCLUDING REAGENT PLATE

(71) Applicant: Nicoya Lifesciences Inc., Kitchener (CA)

(72) Inventor: Sebastian VON DER ECKEN, Concord (CA)

(21) Appl. No.: 18/836,690

(22) PCT Filed: Feb. 6, 2023
(86) PCT No.: PCT/CA2023/050152

§ 371 Date: Aug. 7, 2024

Related U.S. Application Data
(60) Provisional application No. 63/307,224, filed on Feb. 7, 2022.

(51) Int. Cl. B01L 3/00

(52) U.S. Cl. CPC B01L 3/527; B01L 3/502784; B01L 2200/025; B01L 2200/027; B01L 2200/0689; B01L 2200/16; B01L 2300/021; B01L 2300/042; B01L 2400/0478

(57) ABSTRACT

Provided herein are reagent plates, digital microfluidics (“DMF”) cartridges and systems, and methods for using the same. The reagent plate may be used for easily preparing, storing, stabilizing, transporting, and/or dispensing reagents for use with the DMF cartridges and systems. Further, the reagent plates, DMF cartridges and systems may provide easy and safe means for handling a predefined set of reagents and volumes and in a manner that may be automated, low cost, safe, and supporting easy-to-use point of case (“POC”) testing devices.

### CROSS-REFERENCE

This application claims the benefit of U.S. Provisional Application No. 63/307,224, filed Feb. 7, 2022, which is hereby incorporated by reference in its entirety.

### BACKGROUND

Microfluidic systems and devices are used in a variety of applications to manipulate, process and/or analyze biological materials. For example, microfluidic systems and devices are used in point-of-care (POC) applications. One challenge in POC testing is to combine the precise concentrations of samples and reagents. Pipetting is the standard in every laboratory environment. Laboratory workers have been using pipettes practically like an extension of their hand. This makes pipetting extremely desirable when, for example, flexibility in workflows, reagent types, and/or reagent volumes is necessary. However, in certain POC testing applications, a predefined set of reagents and volumes must be handled. Unfortunately, certain drawbacks exist with respect to providing automated, cheap, safe, and easy-to-use POC testing devices.

### SUMMARY

In one aspect, the present disclosure provides a reagent plate for use with a digital microfluidics (“DMF”) cartridge. In some embodiments, the reagent plate comprises one or more holding features for coupling the reagent plate to a top substrate of a DMF cartridge. In some embodiments, the reagent plate comprises one or more reagent reservoirs configured to contain a reagent therein. In some embodiments, the one or more reagent reservoirs each comprise a dispensing nozzle. In some embodiments, the reagent plate comprises one or more reagent actuators configured to cause the reagent to be dispensed from the one or more reagent reservoirs through the dispensing nozzle and into a droplet operations region of the DMF cartridge.

In some embodiments, each of the one or more reagent reservoirs comprises a dispensing nozzle for dispensing the reagent into the droplet operations region of the one or more reagent reservoirs. In some embodiments, the shape of the dispensing nozzle is selected based on the reagent used or an assay to be performed using the DMF cartridge. In some embodiments, the dispensing nozzle is configured to dispense the reagent above, at, or below an oil level of the droplet operations region.

In some embodiments, each of the one or more reagent actuators comprises an actuator rod for depressing a plunger disposed within an opening of the one or more reagent reservoirs. In some embodiments, the length of the actuator rod is selected based on a desired dispensing time.

In some embodiments, the reagent plate further comprises one or more pressure features for providing a proper gap height to a droplet operations gap of the DMF cartridge. In some embodiments, the pressure features are mechanical structures that enable a force to transfer from a center portion of the reagent plate to the top substrate of the DMF cartridge.

In some embodiments, the reagent plate further comprises a seal interface for positioning a seal between the reagent plate and the DMF cartridge for maintaining a liquid within the droplet operations region of the DMF cartridge. In some embodiments, the seal is selected from a gasket, an arrangement of support ribs, and combinations thereof.

In some embodiments, the reagent plate comprises one or more alignment features for reducing an alignment error between the reagent plate and the DMF cartridge. In some embodiments, the one or more alignment features is a visual marker. In some embodiments, the one or more alignment features is an ID code. In some embodiments, the ID code is a bar code or QR code. In some embodiments, the ID code is further configured to allow for the identification of the reagent plate to ensure the proper reagent plate is used from a certain test or assay to be performed using the DMF cartridge.

In some embodiments, each of the one or more reservoirs may be sealed using a reservoir cap for storing the reagent.

In another aspect, the present disclosure provides a DMF cartridge comprising the reagent plate described herein.

In another aspect, the present disclosure provides DMF system comprising the reagent plate described here.

In another aspect, the present disclosure provides a method of performing a test or assay using a digital microfluidics (“DMF”) system. In some embodiments, the method comprises the step of selecting a test or assay to be performed using a DMF system. In some embodiments, the method comprises the step of providing a reagent plate and a DMF cartridge to be used for the selected test or assay. In some embodiments, the method comprises the step of attaching the reagent plate to the DMF cartridge to form a DMF cartridge assembly. In some embodiments, the method comprises the step of installing the DMF cartridge assembly into the DMF system. In some embodiments, the method comprises the step of performing the selected test or assay.

In some embodiments, the step of performing the selected test or assay comprises dispensing a reagent from one or more reagent reservoirs of the reagent plate into a droplet operations region of the DMF cartridge. In some embodiments, each of the one or more reagent reservoirs independently contains a different reagent for performing the selected test or assay. In some embodiments, the step of performing
selected test or assay comprises actuating one or more reagent actuators of the reagent plate to cause the reagent to be dispensed from the one or more reagent reservoirs. In some embodiments, actuating the one or more reagent actuators is performed in a manner to provide slow controlled dispensing of the reagent to avoid any over-pressure conditions. In some embodiments, actuating the one or more reagent actuators comprises depressing a plunger disposed within each of the one or more reagent reservoirs using an actuator rod attached to each of the one or more reagent actuators. In some embodiments, each of the actuator rods independently has a different length to cause the reagent of each of the one or more reagent reservoirs to be dispensed at a different time.

In some embodiments, the step of installing the DMF cartridge assembly comprises identifying an alignment error of the reagent plate with respect to the DMF cartridge.

In some embodiments, the reagent plate is preloaded with one or more reagents for performing the selected test or assay.

Additional aspects and advantages of the present disclosure may become readily apparent to those skilled in this art from the following detailed description, wherein only illustrative embodiments of the present disclosure are shown and described. As may be realized, the present disclosure is capable of other and different embodiments, and its several details are capable of modifications in various obvious respects, all without departing from the disclosure. Accordingly, the drawings and description are to be regarded as illustrative in nature, and not as restrictive.

### Incorporation by Reference

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates a block diagram of an example of the presently disclosed DMF cartridge assembly including a reagent plate that may be used for easily preparing, storing, stabilizing, transporting, and/or dispensing reagents.

FIG. 2 illustrates a block diagram of an example of a DMF system that includes the presently disclosed DMF cartridge assembly shown in FIG. 1 that may include a reagent plate for easily preparing, storing, stabilizing, transporting, and/or dispensing reagents.

FIG. 3 illustrates a top isometric view of an example of a DMF cartridge of the DMF cartridge assembly shown in FIG. 1.

FIG. 4 illustrates a bottom isometric view of the DMF cartridge shown in FIG. 3 and absent the bottom substrate for showing more details of the top substrate.

FIG. 5 illustrates a plan view of an example of a bottom substrate of the DMF cartridge shown in FIG. 3.

FIG. 6 through FIG. 14 illustrate various views of an example of a DMF cartridge assembly that may include a reagent plate for easily preparing, storing, stabilizing, transporting, and/or dispensing reagents.

FIG. 15 through FIG. 23 illustrate various views of an example of a reagent plate of the DMF cartridge assembly shown in FIG. 6 through FIG. 14.

FIG. 24 illustrates an exploded view showing more details of the example DMF cartridge assembly shown in FIG. 3 through FIG. 23.

FIG. 25 and FIG. 26 illustrate cross-sectional views of certain portions of the DMF cartridge assembly shown in FIG. 6 through FIG. 14 and including the reagent plate for easily preparing, storing, stabilizing, transporting, and/or dispensing reagents.

FIG. 27 illustrates a cross-sectional view of the DMF cartridge assembly shown in FIG. 6 through FIG. 14 and showing multiple examples of dispensing nozzles of reagent wells of the reagent plate for easily preparing, storing, stabilizing, transporting, and/or dispensing reagents.

FIG. 28A through FIG. 28E illustrate an example of a process of dispensing liquid from the DMF cartridge assembly shown in FIG. 6 through FIG. 14 and including the reagent plate for easily preparing, storing, stabilizing, transporting, and/or dispensing reagents.

FIG. 29 illustrates a flow diagram of an example of a method of using the presently disclosed DMF system, instrument, and cartridge assembly including the reagent plate for easily preparing, storing, stabilizing, transporting, and/or dispensing reagents.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments, however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Definitions

“Activate,” with reference to one or more electrodes, means affecting a change in the electrical state of the one or more electrodes which, in the presence of a droplet, results in a droplet operation. Activation of an electrode can be accomplished using alternating current (AC) or direct current (DC). Any suitable voltage may be used. For example, an electrode may be activated using a voltage which is greater than about 5 V, or greater than about 20 V, or greater than about 40 V, or greater than about 100 V, or greater than about 200 V or greater than about 300 V. Further, electrode may be activated using a positive and/or negative voltage relative to system ground. Further, deactivated electrodes may be held at ground or floated. The suitable voltage being a function of the dielectric's properties such as thickness and dielectric constant, liquid properties such as viscosity and many other factors as well. Where an AC signal is used, any suitable frequency may be employed. For example, an electrode may be activated using an AC signal having a frequency from about 1 Hz to about 10 MHz, or from about 1 Hz and 10KHz, or from about 10 Hz to about 240 Hz, or about 60 Hz. The method may comprise applying to an affected area of the body of subject suffering from psoriasis any one of the compositions of the present disclosure. The method may further comprise rinsing the affected area to remove the composition.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Non-aqueous components may be solid particles, such as magnetic beads, gold particles, and the like. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as transporting, merging, and/or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more solid particles, such as magnetic beads, gold particles, and the like.

“Droplet Actuator” means a device for manipulating droplets, such as a digital microfluidics (DMF) device or cartridge. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patents application Ser. Nos. 10/343,261, entitled “Electrowetting-driven Micropumping,” filed on Jan. 27, 2003, 11/275,668, entitled “Method and Apparatus for Promoting the Complete Transfer of Liquid Drops from a Nozzle,” filed on Jan. 23, 2006, 11/460,188, entitled “Small Object Moving on Printed Circuit Board,” filed on Jan. 23, 2006, 12/465,935, entitled “Method for Using Magnetic Particles in Droplet Microfluidics,” filed on May 14, 2009, and 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. Nos. 7,641,779, entitled “Method and Apparatus for Programmable fluidic Processing,” issued on Jan. 5, 2010, and 6,977,033, entitled “Method and Apparatus for Programmable fluidic Processing,” issued on Dec. 20, 2005; Decre et al., 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; March and et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, and/or an electrode in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, NJ) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define on-actuator dispensing reservoirs. The spacer height may, for example, be from about 5 μm to about 1000 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g., external syringe pumps, pneumatic membrane pumps, vibrating membrane pumps, vacuum devices, centrifugal forces, piezoelectric/ultrasonic pumps and acoustic forces); electrical or magnetic principles (e.g., electroosmotic flow, electrokinetic pumps, ferrofluidic plugs, electrohydrodynamic pumps, attraction or repulsion using magnetic forces and magnetohydrodynamic pumps); thermodynamic principles (e.g., gas bubble generation/phase-change-induced volume expansion); other kinds of surface-wetting principles (e.g., electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid (which may contain solids) into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly-or per-fluorinated compounds in solution or polymerizable monomers. Examples include TEFLON® AF (available from The Chemours Company, Wilmington, DE), members of the cytop family of materials, coatings in the FLUOROPEL® family of hydrophobic and superhydrophobic coatings (available from Cytonix Corporation, Beltsville, MD), silane coatings, fluorosilane coatings, hydrophobic phosphonate derivatives (e.g., those sold by Aculon, Inc), and NOVEC™ electronic coatings (available from 3M Company, St. Paul, MN), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly (3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose CA); ARLON™ 11N (available from Arlon, Inc, Santa Ana, CA).; NELCO® N4000-6 and N5000-30/32 (available from Park Electrochemical Corp., Melville, NY); ISOLA™ FR406 (available from Isola Group, Chandler, AZ), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, DE); NOMEX® brand fiber (available from DuPont, Wilmington, DE); and paper. Various materials are also suitable for use as the dielectric component of the substrate. Examples include: vapor deposited dielectric, such as PARYLENE™ C, PARYLENE™ N, PARYLENE™ F and PARYLENE™ HT (for high temperature, ˜300° C.) (available from Parylene Coating Services, Inc., Katy, TX); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, NV) (good thermal characteristics for applications involving thermal control), and PROBIMER™ 8165 (good thermal characteristics for applications involving thermal control (available from Huntsman Advanced Materials Americas Inc., Los Angeles, CA); dry film soldermask, such as those in the VACREL® dry film soldermask line (available from DuPont, Wilmington, DE); film dielectrics, such as polyimide film (e.g., KAPTON® polyimide film, available from DuPont, Wilmington, DE), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and Dupont™ Kapton® MBC (available from DuPont, Wilmington, DE). Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, electrode shape, inter-electrode spacing, and gap height (between top and bottom substrates) may be varied for use with specific reagents, protocols, droplet volumes, etc. In some cases, a substrate of the invention may be derivatized with low surface-energy materials or chemistries, e.g., using deposition or in situ synthesis using poly-or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance and/or capacitance sensing and/or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may be completed within about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to or larger than the electrowetting area; in other words, 1×-, 2×- 3×-droplets are usefully controlled and/or operated using 1, 2, and 3 electrodes, respectively. If the droplet footprint is greater than number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator is typically filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in U.S. Patent Pub. No. 20110118132, published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200 C, viscosity=2.4 cSt, d=1.79), Galden HT230 (bp=230 C, viscosity=4.4 cSt, d=1.82) (all from Solvay Solexis); those in the Novec line, such as Novec 7500 (bp=128 C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (<7 cSt is preferred, but not required), and on boiling point (>150° C. is preferred, but not required, for use in DNA/RNA-based applications (PCR, etc.)). Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Washing” with respect to washing a surface, such as a hydrophilic surface, means reducing the amount and/or concentration of one or more substances in contact with the surface or exposed to the surface from a droplet in contact with the surface. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent or buffer.

The terms “top,” “bottom,” “over,” “under,” and “on” are used throughout the description with reference to the relative positions of components of the droplet actuator, such as relative positions of top and bottom substrates of the droplet actuator. It will be appreciated that in many cases the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a dynamic film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### Reagent Plate

In some embodiments, the presently disclosed subject matter provides a digital microfluidics (DMF) system, instrument, and cartridge assembly including a reagent plate that may be used for easily preparing, storing, stabilizing, transporting, and/or dispensing reagents.

In some embodiments, the presently disclosed DMF system, DMF instrument, and DMF cartridge assembly may provide a DMF cartridge assembly including a DMF cartridge and a reagent plate and wherein the DMF cartridge may include a bottom substrate and a top substrate and wherein the reagent plate may be provided separately from the DMF cartridge.

In some embodiments, the presently disclosed DMF system, DMF instrument, and DMF cartridge assembly may provide a DMF cartridge assembly including a DMF cartridge and a reagent plate and wherein the reagent plate may include a set of reagent reservoirs and wherein the number, configurations, and volumes of the reagent reservoirs may vary.

In some embodiments, the presently disclosed DMF system, DMF instrument, and DMF cartridge assembly may provide a DMF cartridge assembly including a DMF cartridge and a reagent plate and wherein the reagent plate may include a set of reagent reservoirs that may be dispensed via linear actuators coupled to plungers of the reagent reservoirs.

In some embodiments, the presently disclosed DMF system, DMF instrument, and DMF cartridge assembly including the reagent plate may provide an easy and safe means for handling a predefined set of reagents and volumes and in a manner that may be automated, low cost, safe, and supporting easy-to-use POC testing devices.

Further, a method is provided for using the presently disclosed DMF system, DMF instrument, and DMF cartridge assembly including the reagent plate for easily preparing, storing, stabilizing, transporting, and/or dispensing reagents.

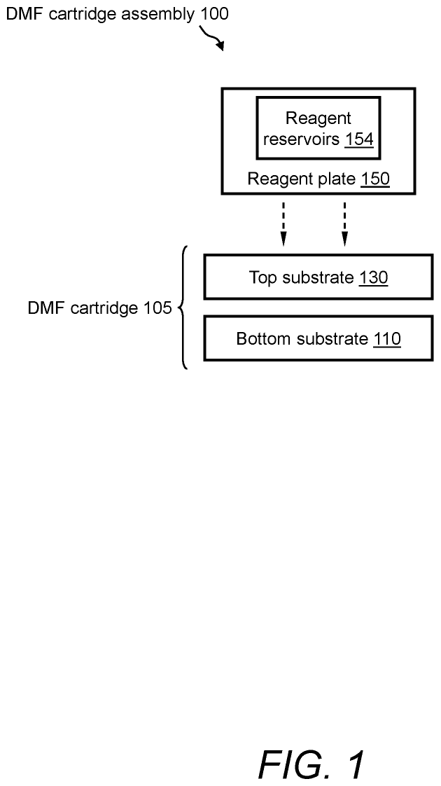

Referring now to FIG. 1 is a block diagram of an example of the presently disclosed DMF cartridge assembly 100 including a reagent plate that may be used for easily preparing, storing, stabilizing, transporting, and/or dispensing reagents.

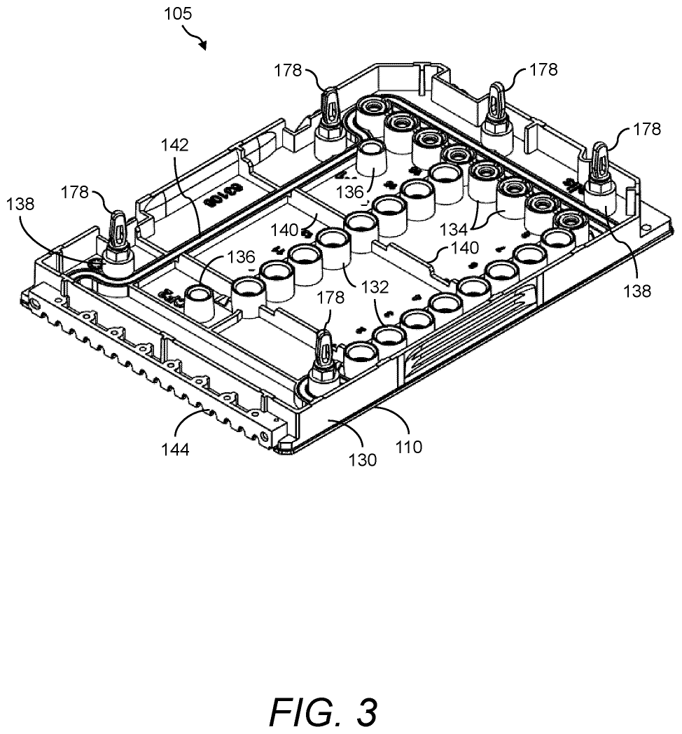

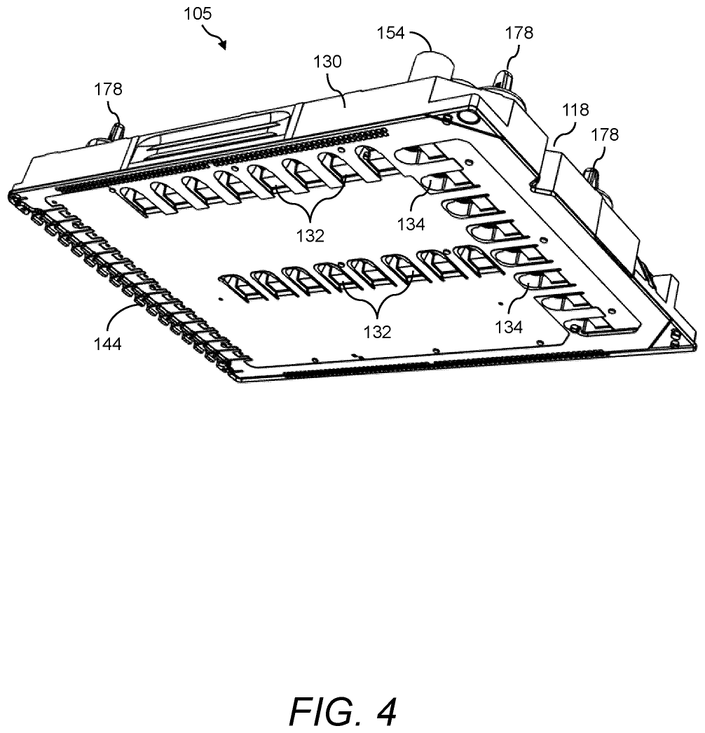

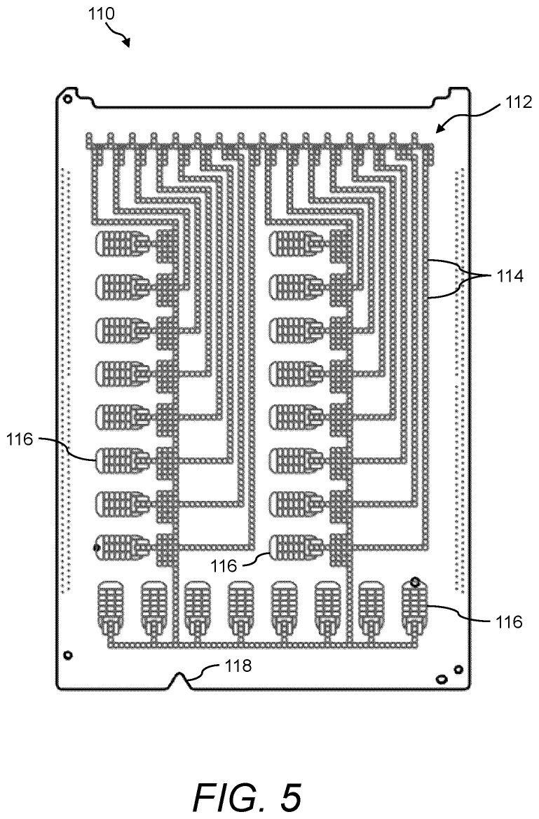

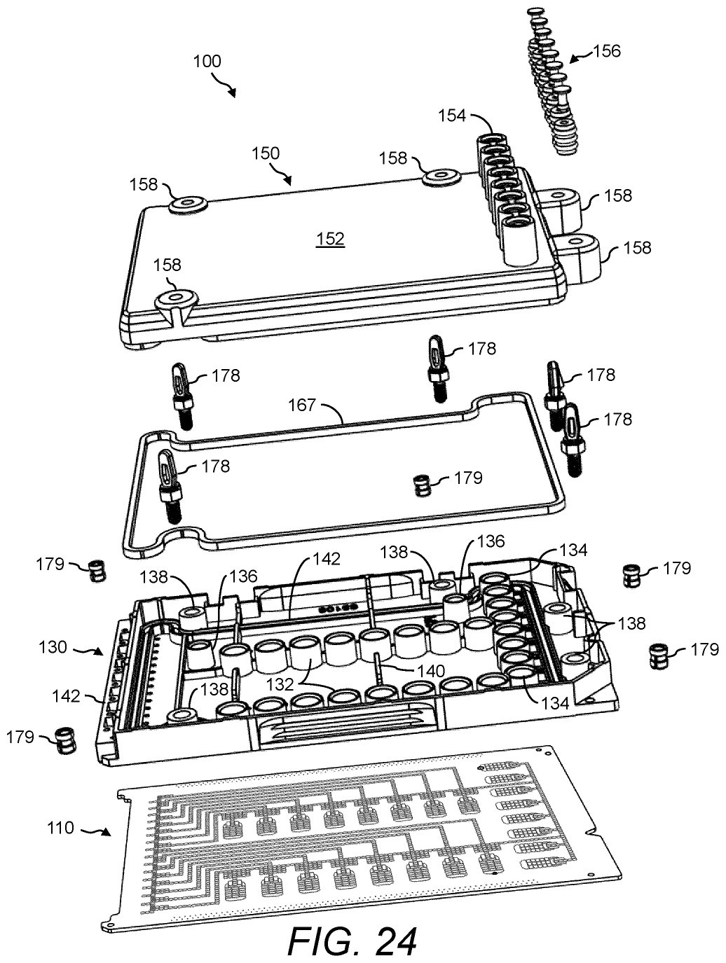

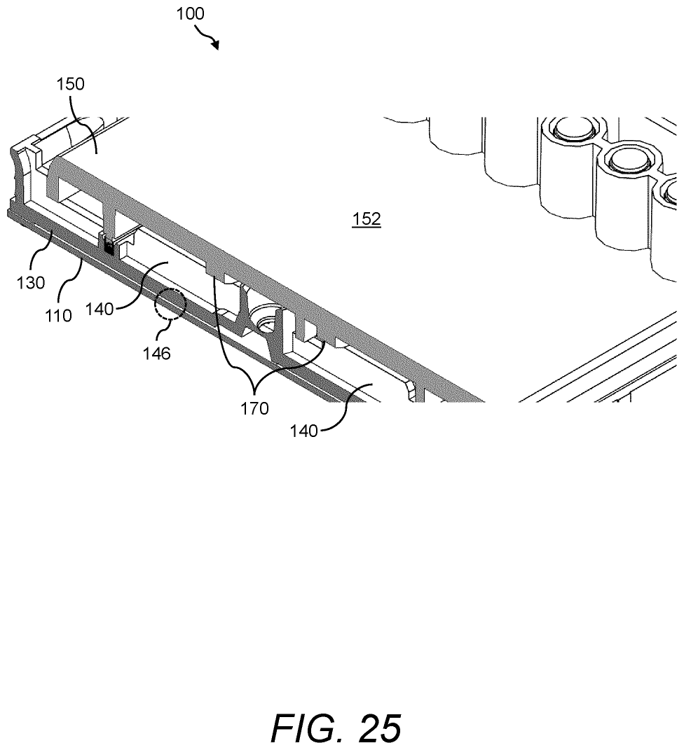

DMF cartridge assembly 100 may include, for example, a DMF cartridge 105 that may include a bottom substrate 110 and a top substrate 130. Generally, DMF devices consist of two substrates separated by a gap that forms a chamber in which the droplet operations are performed. Accordingly, DMF cartridge 105 consists of bottom substrate 110 and top substrate 130 separated by a gap (see FIG. 25) that forms a chamber in which the droplet operations are performed. Bottom substrate 110 may be, for example, a silicon or printed circuit board (PCB) substrate. More details of an example of a PCB-based bottom substrate 110 are shown and described hereinbelow with reference to FIG. 5 and FIG. 24. Top substrate 130 may be, for example, a glass or plastic substrate. More details of an example of a plastic top substrate 130 are shown and described hereinbelow with reference to FIG. 3, FIG. 4, and FIG. 24.

DMF cartridge 105 may facilitate DMF capabilities generally for fluidic actuation including droplet merging, splitting, dispensing, diluting, and the like. One application of these DMF capabilities may be sample preparation. However, the DMF capabilities may be used for other processes, such as waste removal. DMF cartridge 105 of DMF cartridge assembly 100 may be provided, for example, as a disposable and/or reusable cartridge.

Provided separately from DMF cartridge 105, DMF cartridge assembly 100 may include a reagent plate 150 that further includes a plurality of reagent reservoirs 154 for holding any types and/or volumes of liquid, such as reagent solution. Generally, reagent plate 150 is designed for easily preparing, storing, stabilizing, transporting, and/or dispensing reagents. In one example, reagent plate 150 is designed to mechanically and fluidly couple to top substrate 130 of DMF cartridge 105. Reagent plate 150 may include any number, configurations, and/or volumes of reagent reservoirs 154. Reagent reservoirs 154 of reagent plate 150 may be preloaded with test-specific reagent or reagents. In one example, reagent reservoirs 154 of reagent plate 150 may be preloaded with one or more reagents specific for COVID-19 testing. Further, in one example, reagent plate 150 may be formed of plastic. In some embodiments, the plastic reagent plate 150 may be substantially transparent to allow optical detection methods.

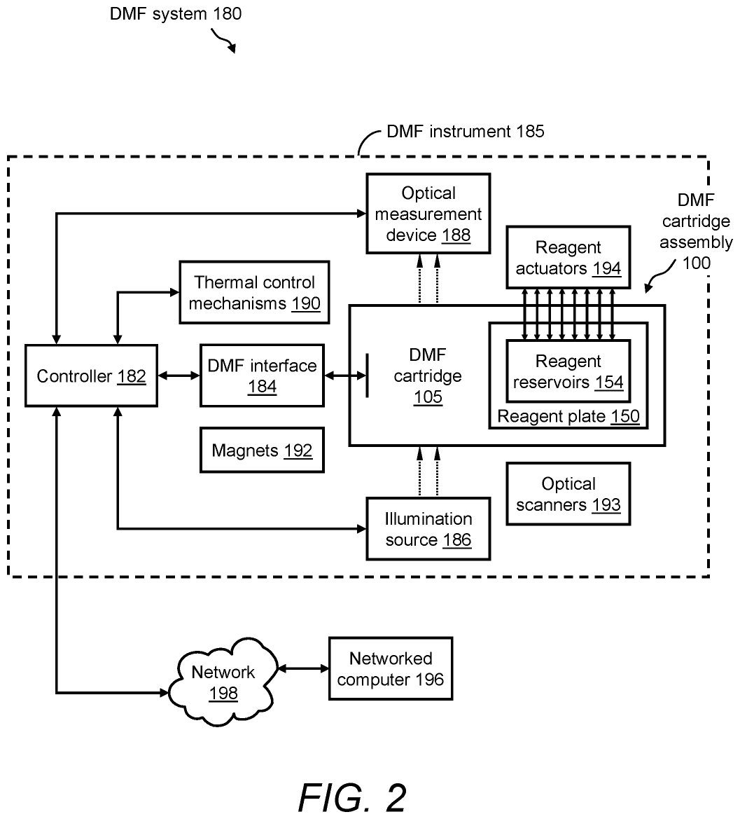

Referring now to FIG. 2 is a block diagram of an example of a DMF system 180 that includes the presently disclosed DMF cartridge assembly 100 shown in FIG. 1 that may include reagent plate 150 for easily preparing, storing, stabilizing, transporting, and/or dispensing reagents. DMF system 180 including DMF cartridge 105 and reagent plate 150 may be used in a variety of applications to manipulate, process, and/or analyze biological materials. For example, DMF system 180 may be used in point-of-care (POC) applications.

DMF system 180 may further include a controller 182, a DMF interface 184, an illumination source 186, an optical measurement device 188, thermal control mechanisms 190, one or more magnets 192, one or more optical scanners 193, and one or more reagent actuators 194. Controller 182 may be electrically coupled to the various hardware components of DMF system 180, such as to DMF cartridge 105, illumination source 186, optical measurement device 188, thermal control mechanisms 190, magnets 192, and optical scanners 193. Additionally, a set of reagent actuators 194 may be provided in relation to reagent reservoirs 154 of reagent plate 150. Reagent actuators 194 may be controlled via controller 182.

In particular, controller 182 may be electrically coupled to DMF cartridge 105 via DMF interface 184, wherein DMF interface 184 may be, for example, a pluggable interface for connecting mechanically and electrically to DMF cartridge 105. Together, DMF cartridge 105, controller 182, DMF interface 184, illumination source 186, optical measurement device 188, thermal control mechanisms 190, magnets 192, optical scanners 193, and reagent actuators 194 may comprise a DMF instrument 185.

Controller 182 may, for example, be a general-purpose computer, special purpose computer, personal computer, tablet device, smartphone, smart watch, microprocessor, or other programmable data processing apparatus. Controller 182 may provide processing capabilities, such as storing, interpreting, and/or executing software instructions, as well as controlling the overall operations of DMF system 180. The software instructions may comprise machine readable code stored in non-transitory memory that is accessible by the controller 182 for the execution of the instructions. Controller 182 may be configured and programmed to control data and/or power aspects of these devices. For example, with respect to DMF cartridge 105, controller 182 may control droplet manipulation by activating/deactivating electrodes. Generally, controller 182 may be used for any functions of the DMF system 180. For example, controller 182 may be used to authenticate the DMF cartridge 105 in a fashion similar to how printer manufacturers check for their branded ink cartridges, controller 182 may be used to verify that the DMF cartridge 105 is not expired, controller 182 may be used to confirm the cleanliness of the DMF cartridge 105 by running a certain protocol for that purpose, and so on.

Additionally, in some embodiments, DMF cartridge 105 may include capacitive feedback sensing. For example, a signal may be generated or detected by a capacitive sensor that can detect droplet position, velocity, and size. Further, in other embodiments, instead of capacitive feedback sensing, DMF cartridge 105 may include a camera or other optical device to provide an optical measurement of the droplet position, velocity, and size, which can trigger controller 182 to re-route the droplets at appropriate positions. The feedback may be used to create a closed-loop control system to optimize droplet actuation rate and verify droplet operations are completed successfully.

Further, in some embodiments, controller 182 may be external to DMF instrument 185. The functions described above may be done remotely, for example, via a mobile application running on a mobile device connected to various components (i.e., illumination source 186, among others) via a local network or other network. Output from optical measurement device 188 may also be sent to an external controller 182 via such networks, and displayed on the mobile application or another mobile app running on a mobile device specific for the external controller 182.

Optionally, DMF instrument 185 may be connected to a network. For example, controller 182 may be in communication with a networked computer 196 via a network 198. Networked computer 196 may be, for example, any centralized server or cloud server. The servers may be, for example, virtual servers, with logical drives distributed across geographically diverse physical drives. Network 198 may be, for example, a local area network (LAN) or wide area network (WAN) for connecting to the internet. Though FIG. 1 shows a single Networked computer 196, multiple computers (physical or virtual) may be connected to DMF system 180 via Network 198. For example, one computer may be used to control illumination source 186, another computer may be used to control thermal control mechanisms 190, and another computer that is optimized for storing information may be used to store data received from optical measurement device 188, and yet another computer that is optimized for processing data may be used to process information received from DMF instrument 185.

In DMF system 180, illumination source 186 and optical measurement device 188 may provide a detection system of DMF instrument 185. The illumination source 186 may be, for example, a light source for the visible range (400-800 nm), such as, but not limited to, a white light-emitting diode (LED), a halogen bulb, an arc lamp, an incandescent lamp, lasers, and the like. Illumination source 186, in some embodiments, may be a “smart” bulb, capable of being operated and controlled via a mobile device. In addition to different wave lengths (i.e., different colors), the brightness may also be adjusted via the mobile device. Illumination source 186 is not limited to a white light source. Illumination source 186 may be any color light that is useful in DMF system 180. Optical measurement device 188 may be used to obtain light intensity readings. Optical measurement device 188 may be, for example, a charge coupled device, a photodetector, a spectrometer, a photodiode array, a smartphone camera, or any combinations thereof. Further, DMF system 180 is not limited to one illumination source 186 and one optical measurement device 188 only. DMF system 180 may include multiple illumination sources 186 and/or multiple optical measurement devices 188 to support multiple sensing elements.

Thermal control mechanisms 190 of DMF instrument 185 may be any mechanisms for controlling the operating temperature of DMF cartridge 105. Examples of thermal control mechanisms 190 may include Peltier elements and resistive heaters.

Magnets 192 of DMF system 180 may be any permanent magnets, electromagnets, or both. Optionally, DMF system 180 may include magnet control mechanisms (not shown) for controlling magnets 192.

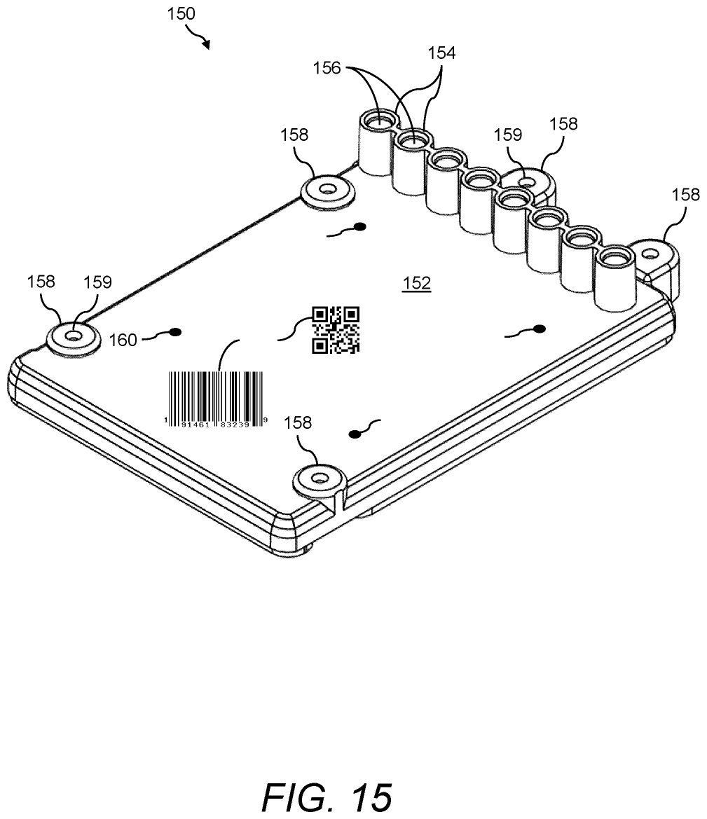

Optical scanners 193 of DMF instrument 185 may be any standard optical scanner devices used, for example, to scan barcodes, QR codes, and the like. For example, optical scanners 193 may be digital cameras. Optical scanners 193 may be located on the outside body of DMF instrument 185 and/or internal to DMF instrument 185 and in close proximity to DMF cartridge assembly 100 when installed. In one example, optical scanners 193 may be used to scan barcodes and/or QR codes affixed to, for example, DMF cartridge 105 and/or reagent plate 150 (see FIG. 15).

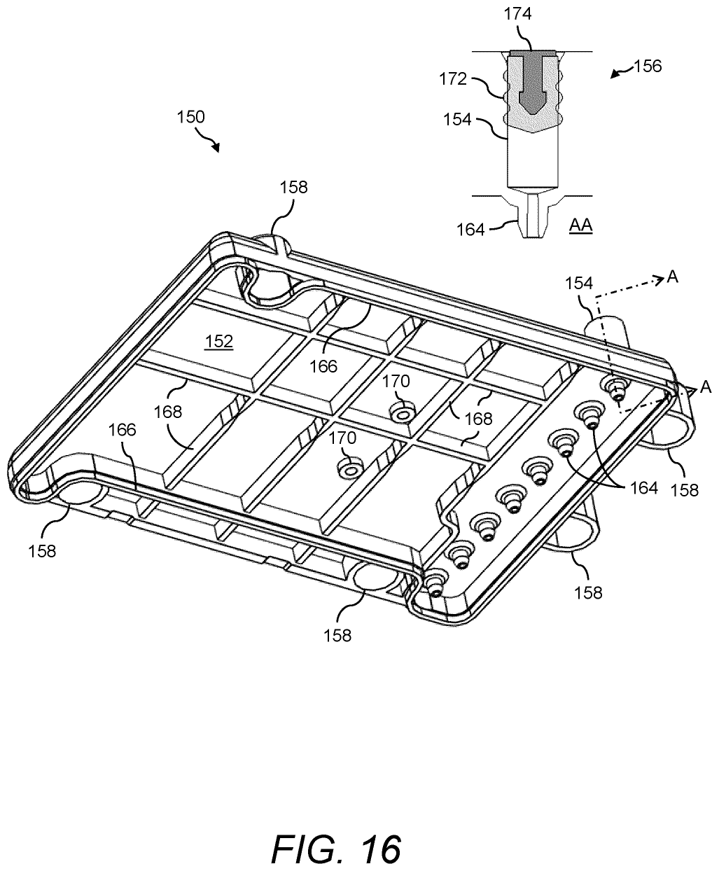

Each of the reagent reservoirs 154 of reagent plate 150 has a plunger (see FIG. 16). The set of reagent actuators 194 are provided in relation to the plungers of the reagent reservoirs 154. For example, there may be one reagent actuator 194 for each of the respective reagent reservoirs 154 of reagent plate 150. Each of the reagent actuators 194 is used to dispense reagent solution from its corresponding reagent reservoir 154. In one example, the reagent actuators 194 may be actuated at substantially the same time. In another example, one or more of the reagent actuators 194 may be actuated at different times.

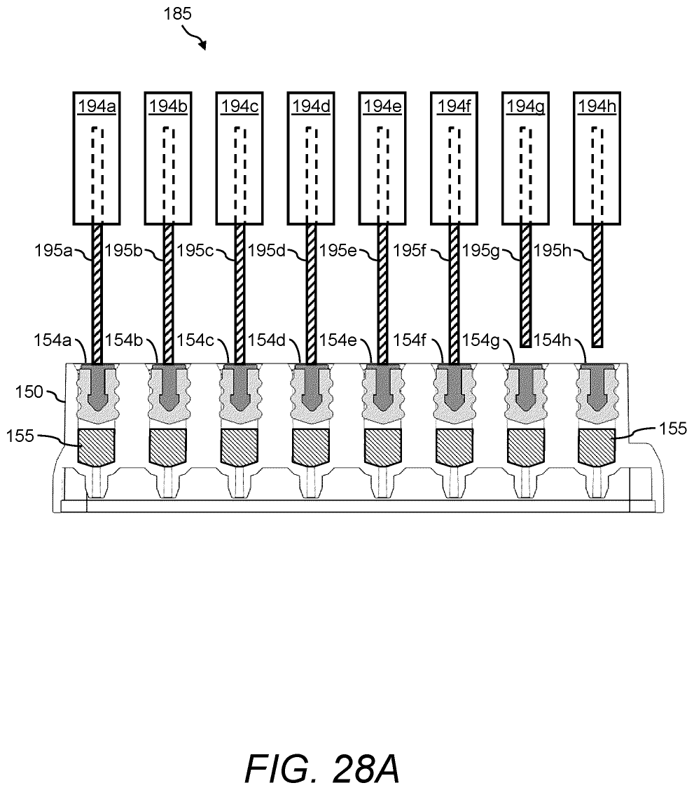

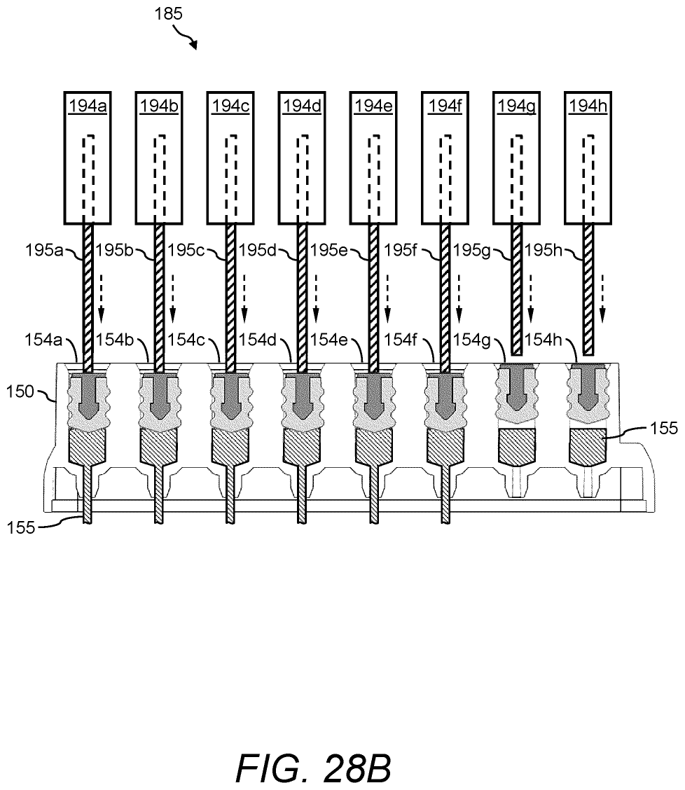

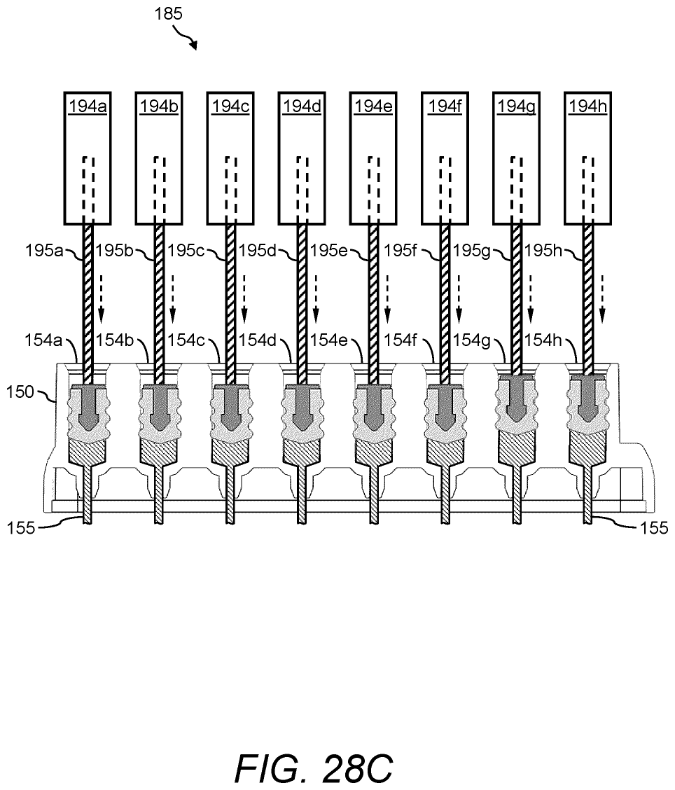

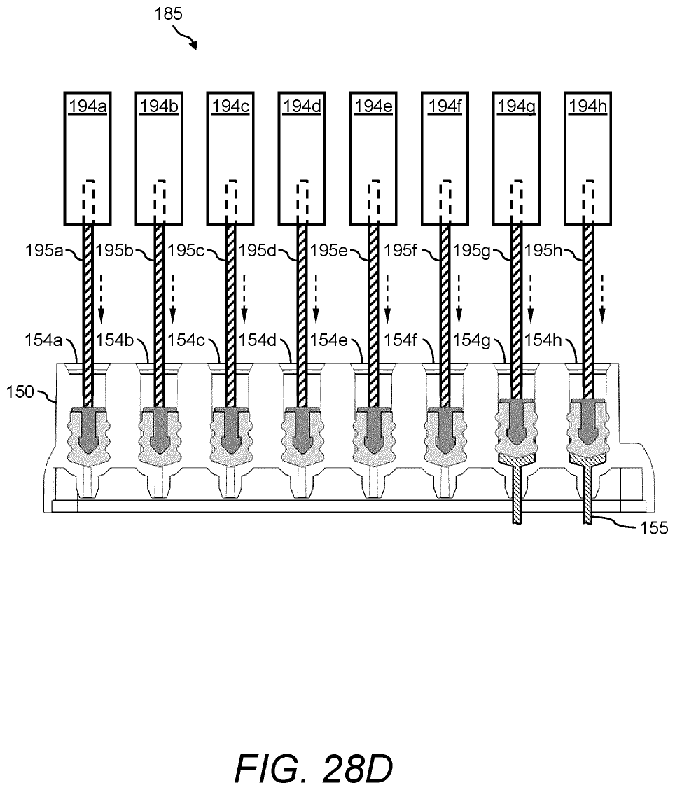

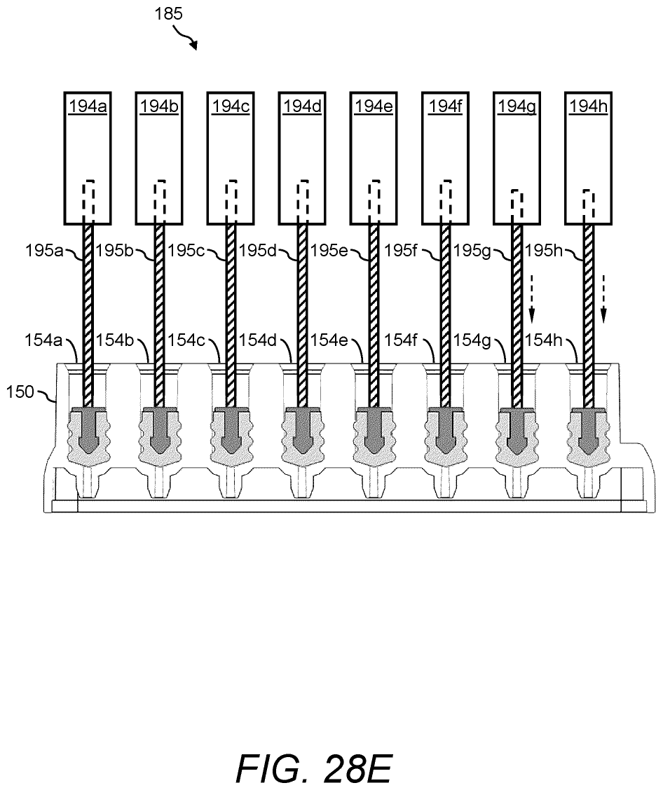

In one example, each reagent actuator 194 may include an actuator rod (see FIG. 28A through FIG. 28E) that may be coupled linearly to the plunger of a corresponding reagent reservoir 154. That is, the actuator rod is designed to push on the plunger of reagent reservoir 154 for dispensing liquid therefrom.

Referring now to FIG. 3 is a top isometric view of an example of a DMF cartridge 105 of DMF cartridge assembly 100 shown in FIG. 1. In this example, DMF cartridge 105 may include a PCB-based bottom substrate 110 and a plastic top substrate 130 separated by a droplet operations gap 146 (see FIG. 25).

In this example, top substrate 130 may include sixteen sample reservoirs 132. In one example, top substrate 130 may include one line of eight sample reservoirs 132 near a central portion of top substrate 130 and another line of eight sample reservoirs 132 near one edge of top substrate 130, as shown in FIG. 3. Additionally, top substrate 130 may include eight reagent reservoirs 134 arranged along one end of top substrate 130. Further, top substrate 130 may include two oil filler ports 136. One oil filler port 136 near each end of top substrate 130.

The multiple sample reservoirs 132 and multiple reagent reservoirs 134 supply fluidly a droplet operations region of DMF cartridge 105 that may be bounded by a seal channel 142 of top substrate 130. Seal channel 142 may be, for example, a molded channel for holding a seal 167 (e.g., a rubber gasket, see FIG. 24). Seal 167 provides the sealing mechanism between DMF cartridge 105 and reagent plate 150 of DMF cartridge assembly 100 for ensuring no leaking of liquids from the droplet operations region of DMF cartridge 105.

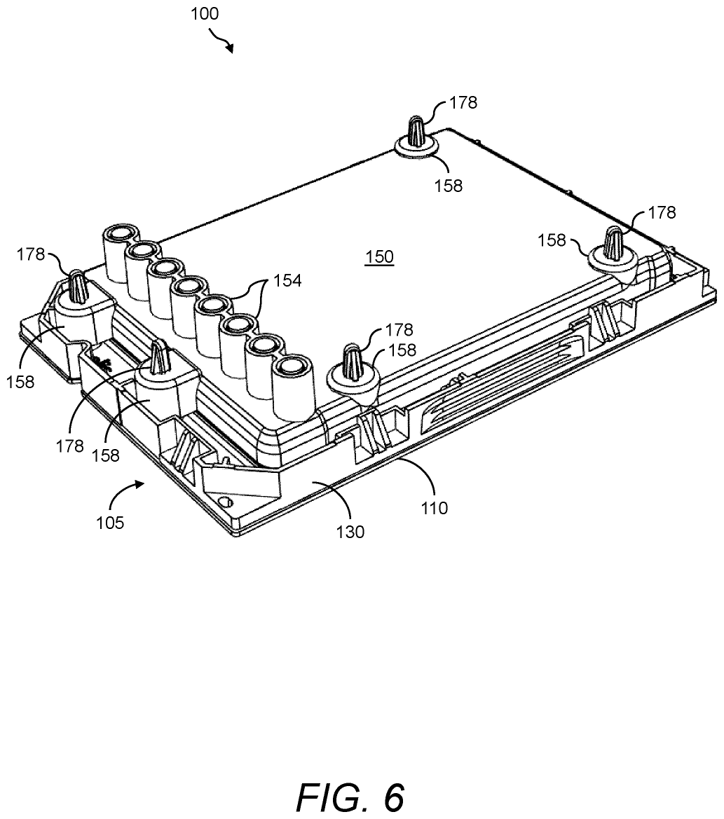

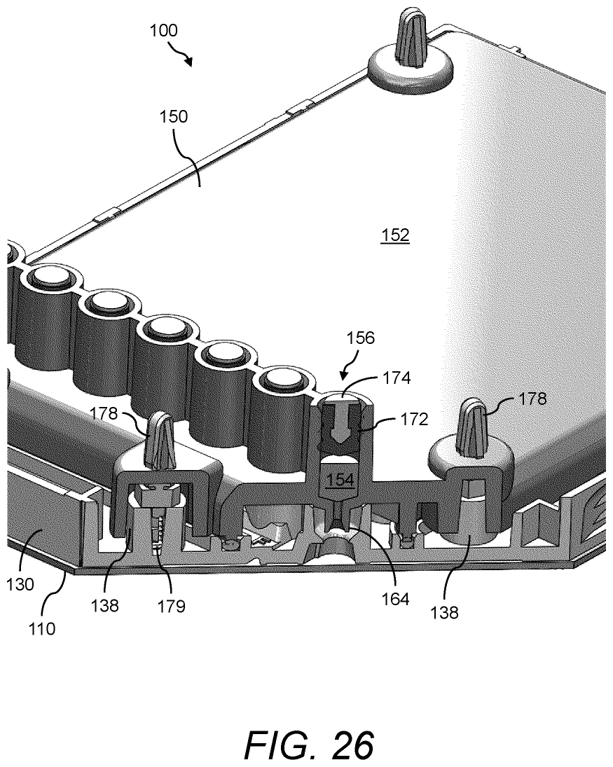

Further, top substrate 130 may include a set of five snap pin receivers 138. The five snap pin receivers 138 may be provided outside of seal channel 142, which outside the droplet operations region of DMF cartridge 105. More specifically, the five snap pin receivers 138 are arranged spatially about the area of top substrate 130. Snap pin receivers 138 are provided to facilitate the coupling of reagent plate 150 to top substrate 130 (see FIG. 6 through FIG. 24). For example, each of the snap pin receivers 138 are designed to hold a snap pin 178. Further, a snap pin insert 179 (see FIG. 24 and FIG. 26) is first installed in each of the snap pin receivers 138. Each snap pin 178 is held in its corresponding snap pin receiver 138 by screwing a threaded end of snap pin 178 into the snap pin insert 179 in the snap pin receiver 138.

Further, the overall structure of top substrate 130 may be supported and/or strengthened by an arrangement of support ribs (or walls) 140, as shown in FIG. 3. Further, an optical fiber guide 144 may be provided at the end of DMF cartridge 105 opposite the eight reagent reservoirs 134.

Referring now to FIG. 4 is a bottom isometric view of DMF cartridge 105 shown in FIG. 3 and absent the bottom substrate 110 for showing more details of top substrate 130. For example, FIG. 4 shows sample reservoirs 132 and reagent reservoirs 134 opening toward the droplet operations gap 146 of DMF cartridge 105. Further, an alignment notch 118 may be provide at one edge of DMF cartridge 105, for example, at the end near reagent reservoirs 134. For example, alignment notch 118 may be used as an installation guide when installing DMF cartridge 105 into DMF instrument 185.

Referring now to FIG. 5 is a plan view of an example of bottom substrate 110 of the DMF cartridge 105 shown in FIG. 3. In this example, bottom substrate 110 may include an electrode arrangement 112. Electrode arrangement 112 may further include various lines, paths, and/or arrays of droplet operations electrodes 114 that supply various arrangements of reservoir electrodes 116. For example, certain reservoir electrodes 116 support the first line of eight sample reservoirs 132. Certain other reservoir electrodes 116 support the second line of eight sample reservoirs 132. Certain other reservoir electrodes 116 support the line of eight reagent reservoirs 134. Accordingly, bottom substrate 110 provides a droplet operations surface with respect to electrode arrangement 112. Additionally, alignment notch 118 is provided at one end of bottom substrate 110.

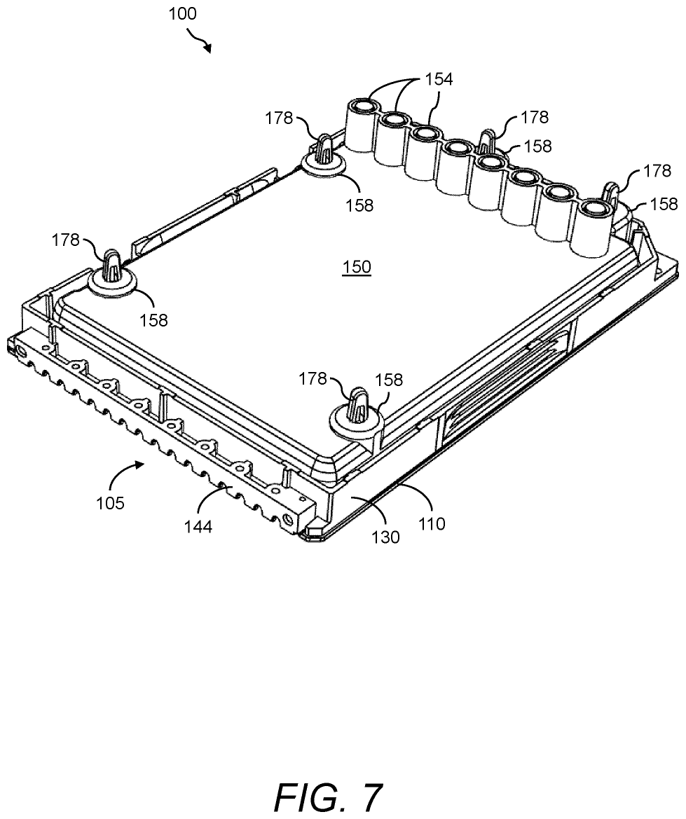

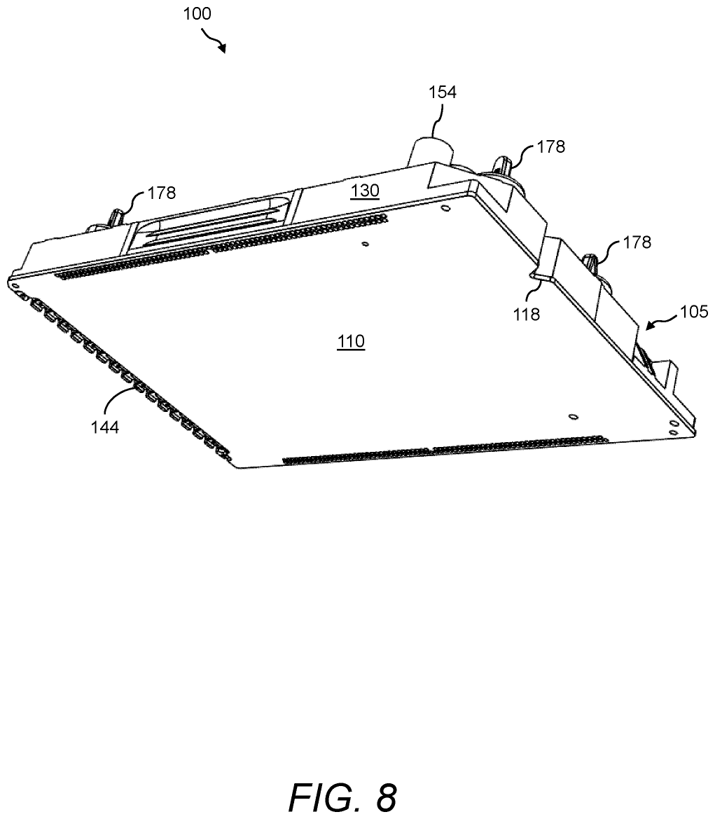

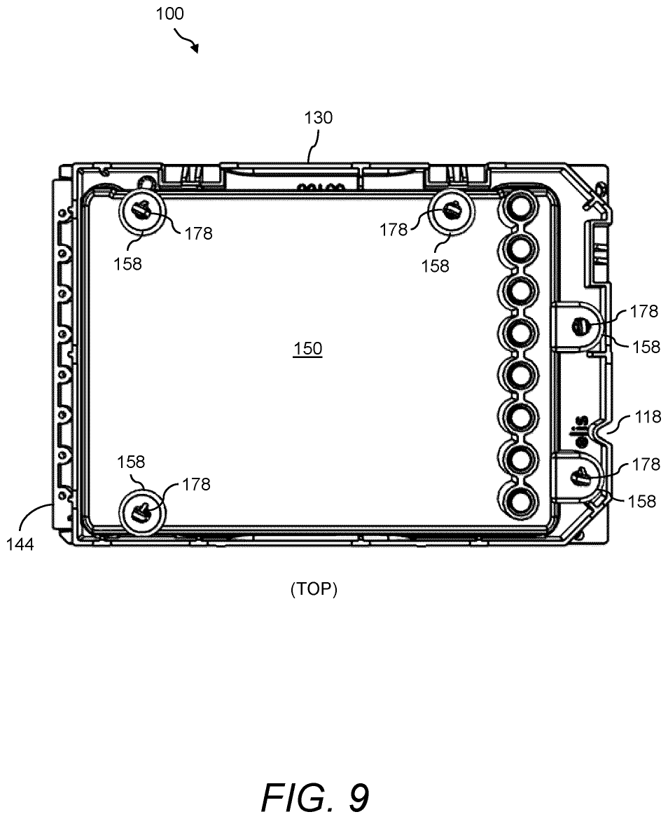

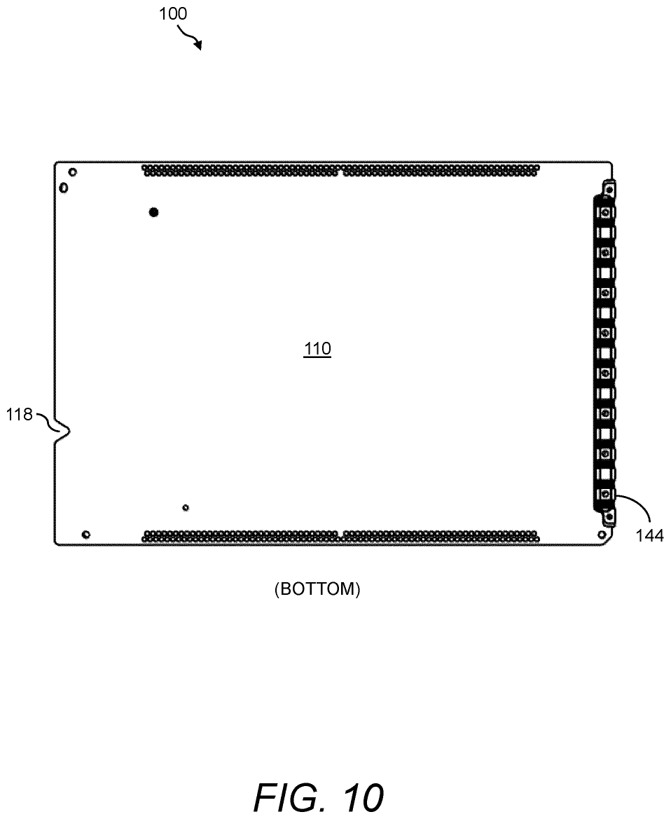

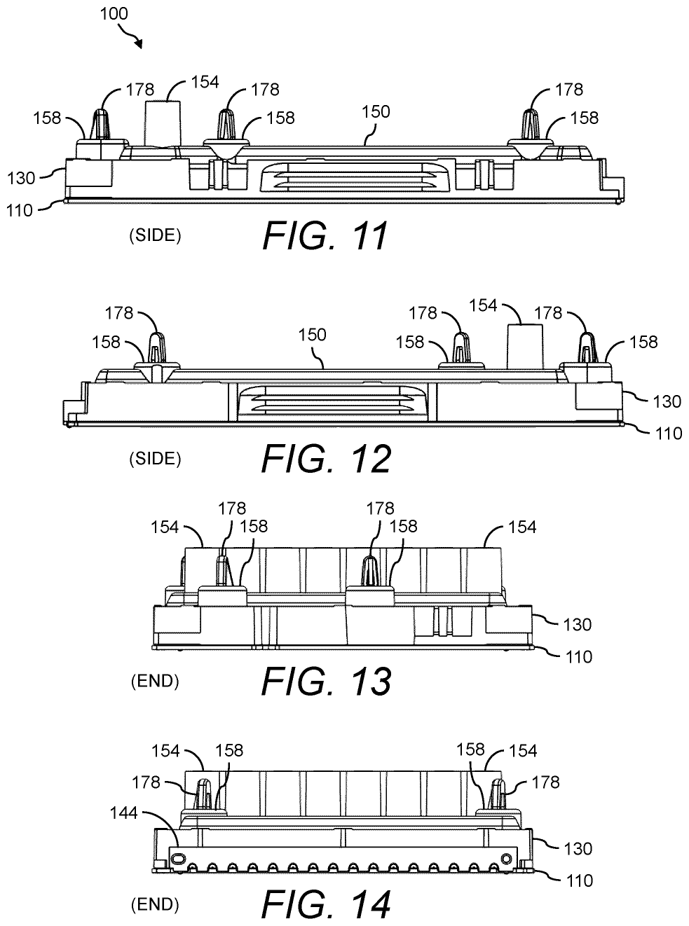

Referring now to FIG. 6 through FIG. 14 is various views of an example of DMF cartridge assembly 100 that may include reagent plate 150 for easily preparing, storing, stabilizing, transporting, and/or dispensing reagents. For example, FIG. 6 and FIG. 7 show top isometric views, FIG. 8 shows a bottom isometric view, FIG. 9 shows a top plan view, FIG. 10 shows a bottom plan view, FIG. 11 shows a first side view, FIG. 12 shows a second side view, FIG. 13 shows a first end view, and FIG. 14 shows a second end view of DMF cartridge assembly 100.

As shown in FIG. 6 through FIG. 14, DMF cartridge assembly 100 generally includes reagent plate 150 that is mechanically and/or fluidly coupled to DMF cartridge 105 (i.e., bottom substrate 110 and top substrate 130). More specifically, reagent plate 150 may be mechanically and/or fluidly coupled to top substrate 130 of DMF cartridge 105 using snap pins 178. For example, reagent plate 150 may include an arrangement of five holding features 158 that substantially corresponds to the arrangement of five snap pins 178 of top substrate 130. Each of the holding features 158 has an opening 159 (see FIG. 15) wherein the snap pins 178 may be snap-fitted into the openings 159 in holding features 158. More details of reagent plate 150 are shown and described hereinbelow with reference to FIG. 15 through FIG. 23.

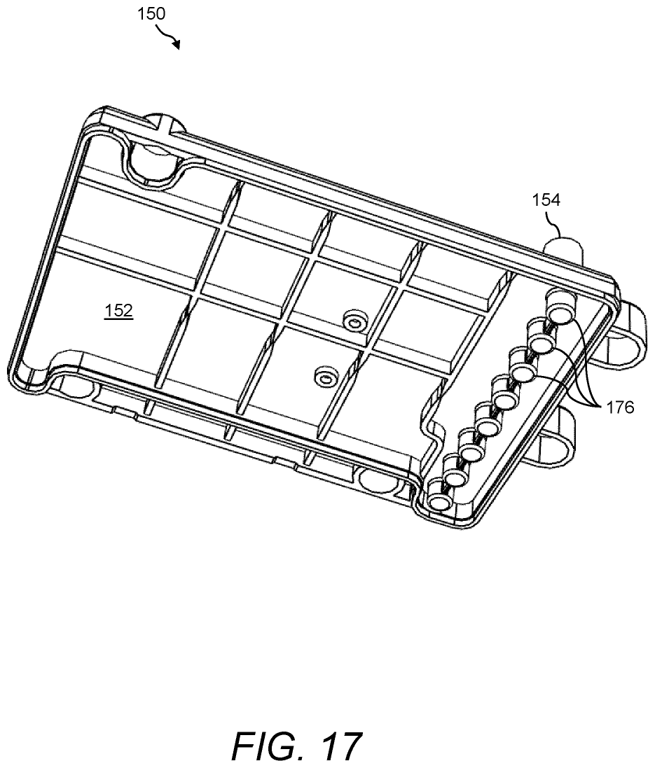

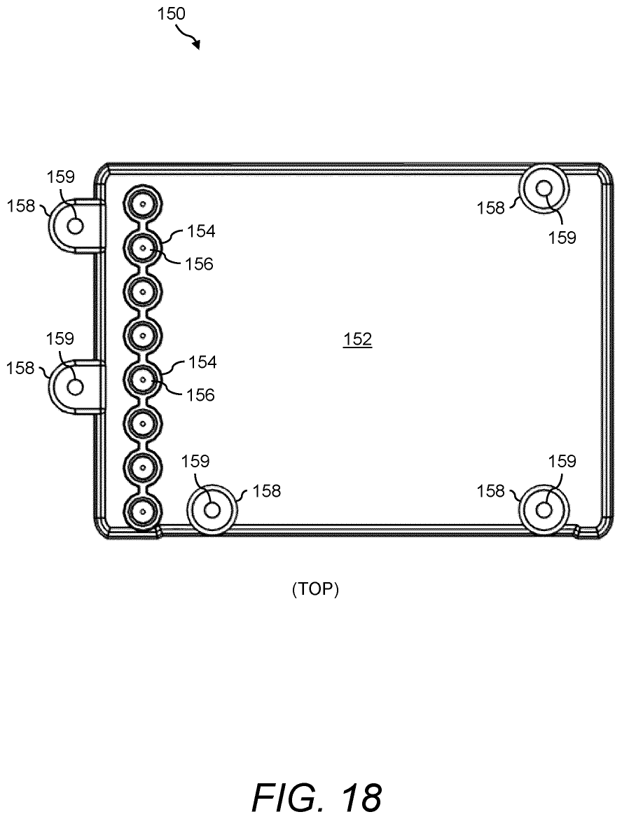

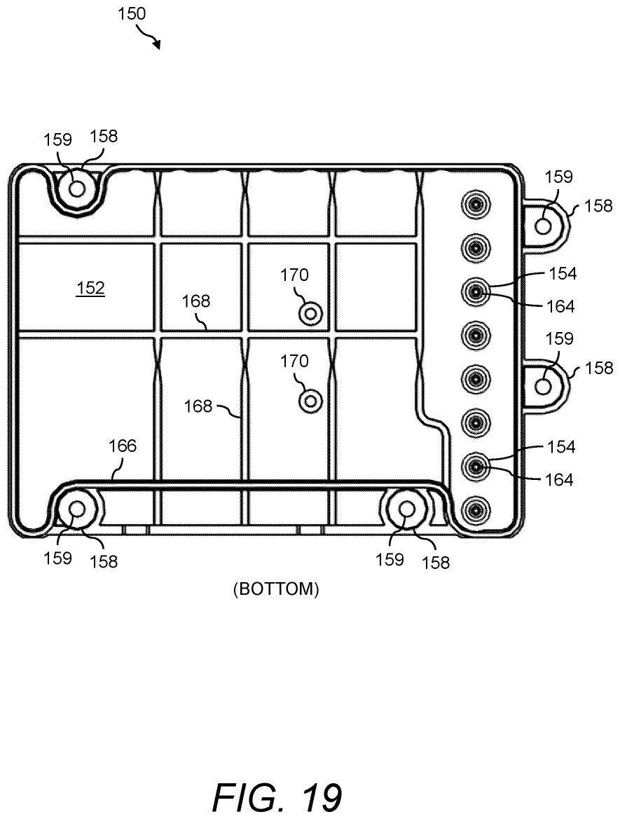

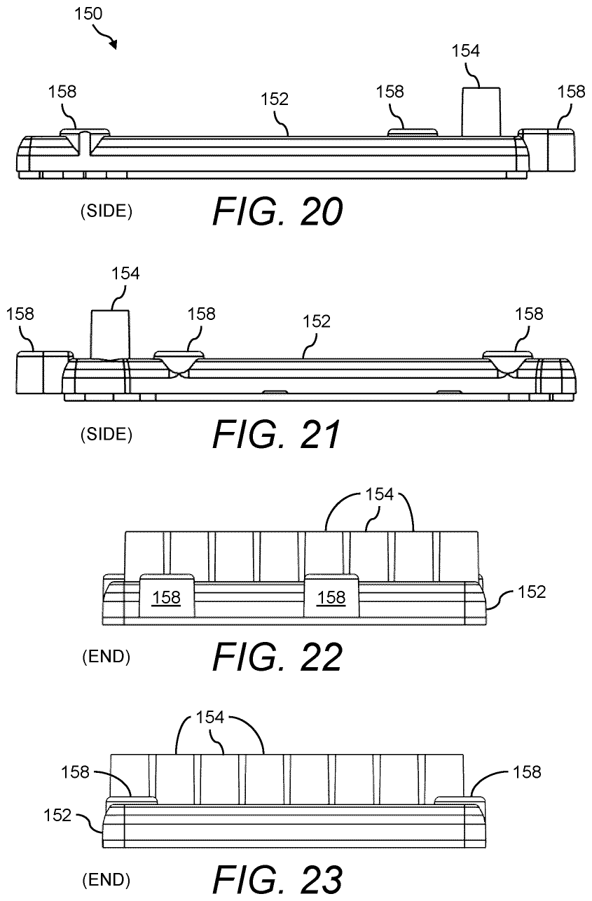

Referring now to FIG. 15 through FIG. 23 is various views of an example of reagent plate 150 of the DMF cartridge assembly 100 shown in FIG. 6 through FIG. 14. For example, FIG. 15 shows a top isometric view, FIG. 16 and FIG. 17 show bottom isometric views, FIG. 18 show a top plan view, FIG. 19 shows a bottom plan view, FIG. 20 shows a first side view, FIG. 21 shows a second side view, FIG. 22 shows a first end view, and FIG. 23 shows a second end view of reagent plate 150.

In this example, reagent plate 150 may include a reagent plate body 152, the eight reagent reservoirs 154 arranged at one end of reagent plate body 152, plungers 156 within the eight reagent reservoirs 154, the five holding features 158 with the openings 159 for receiving the snap pins 178, a set of alignment features 160 atop the reagent plate body 152, and certain ID coding 162 (e.g., barcode, QR code) atop the reagent plate body 152.

Further, FIG. 16 shows the underside of reagent plate 150, which shows that each of the reagent reservoirs 154 has a dispensing nozzle 164. Further, the underside of reagent plate 150 has a seal interface 166 for pressing against seal 167 (e.g., a rubber gasket, see FIG. 24) and an arrangement of support ribs (or walls) 168.

Further, reagent plate 150 may include, for example, a pair of pressure features 170 located at a central portion of reagent plate 150. Pressure features 170 are provided to press against the support ribs (or walls) 140 of top substrate 130 and to ensure the proper gap height of the droplet operations gap 146 (see FIG. 25) of DMF cartridge 105. That is, pressure features 170 provide mechanical structures to enable force-transfer, especially, but not limited to, from a center portion of reagent plate 150 to a center portion of top substrate 130, to a center portion of bottom substrate 110, to ensure that all (or as many as possible) of the high-setting-features (not shown) of top substrate 130 are in contact with bottom substrate 110 (which consists of, for example, PCB, dielectric, coatings, etc.). Further gravity may apply pressure to the reagent plate and DMF cartridge to ensure the droplet operations gap has a proper gap height.

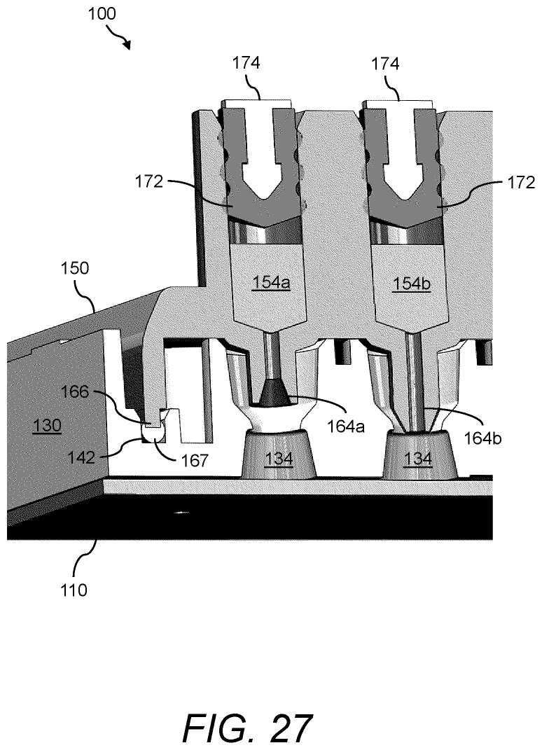

Further, a cross-sectional view taken along line A-A of FIG. 16 shows that each reagent reservoir 154 may be, for example, a cylinder that houses a plunger seal 172 and a plunger rod 174. A volume of liquid (e.g., reagent solution) may be held in the space between plunger seal 172 and dispensing nozzle 164. In operation, pressure may be applied to plunger rod 174 which pushes plunger seal 172 toward dispensing nozzle 164. In so doing, liquid (not shown) may be dispensed out of dispensing nozzle 164. Various designs of dispensing nozzle 164 are possible. More details of examples of different dispensing nozzles 164 are shown and described hereinbelow with reference to FIG. 26 and FIG. 27. Further, more details of an example of the operation of reagent reservoirs 154 are shown and described hereinbelow with reference to FIG. 28A through FIG. 28E.

Because reagent plate 150 may be provided separately from DMF cartridge 105 in a pre-filled state, reservoir caps 176 may be provided at dispensing nozzles 164 of reagent plate 150, as shown in FIG. 17. Accordingly, reagent plate 150 may be provided for easily preparing, storing, stabilizing, transporting, and/or dispensing reagents.

Referring now again to FIG. 15, when installing reagent plate 150 atop DMF cartridge 105 within DMF instrument 185 there may be any types of 3D errors in placement (e.g., X-Y-Z, rotated, tilted, etc.). Accordingly, alignment features 160 may be provided atop the reagent plate body 152. Alignment features 160 may be any types of visual markers, such as dots, across the surface of reagent plate body 152. Optical scanners 193 (e.g., cameras) may be used to analyze these alignment features 160 and very accurately calculate the plane and 3D placement of reagent plate 150. Accordingly, alignment features 160 may be provided to ensure proper placement of reagent plate 150 atop DMF cartridge 105.

In another example, the ID coding 162 (e.g., barcode, QR code) atop the reagent plate body 152 may be used similarly to ensure proper placement of reagent plate 150 atop DMF cartridge 105. Further, the information indicated in ID coding 162 (e.g., barcode, QR code) may be used to ensure the proper reagent plate 150 is selected for a certain test or assay to be run.

Further to the example, FIG. 24 shows an exploded view showing more details of the example DMF cartridge assembly 100 shown in FIG. 3 through FIG. 23.

Referring now to FIG. 25 and FIG. 26 is cross-sectional views of certain portions of the DMF cartridge assembly 100 shown in FIG. 6 through FIG. 14 and including the reagent plate 150 for easily preparing, storing, stabilizing, transporting, and/or dispensing reagents. For example, FIG. 25 shows an example of the two pressure features 170 of reagent plate 150 pressing against the support ribs (or walls) 140 of top substrate 130 to ensure the proper gap height of the droplet operations gap 146 of DMF cartridge 105.

Further, FIG. 26 shows an example of a snap pin insert 179 installed in a snap pin receiver 138. Then, the threaded end of a snap pin 178 is screwed into the snap pin insert 179 in the snap pin receiver 138. Additionally, FIG. 26 shows an example of a “flared” or “wide” dispensing nozzle 164 of reagent reservoir 154. Further to the example, FIG. 27 is a cross-sectional view showing other examples of dispensing nozzles 164. For example, dispensing nozzles 164 may have different lengths and different shaped openings. In FIG. 27, a reagent reservoir 154a has a short dispensing nozzle 164 with a “flared” or “wide” opening. By contrast, a reagent reservoir 154b has a longer dispensing nozzle 164 with a “narrow” or “pointy” opening. With respect to the length of the dispensing nozzle 164, any reagent reservoir 154 may be designed to dispense above the oil level, at the oil level, or below the oil level.

Further, dispensing nozzles 164 may be used for pre-loading the reagent reservoirs 154 with liquid (e.g., reagent solution). For example, reagent plate 150 may be held upside-down and then the reagent reservoirs 154 filled through dispensing nozzles 164. Accordingly, the shape of dispensing nozzles 164 may aid in the loading process. For example, a certain filling process may favor the “flared” or “wide” openings while a different filling process may favor the “narrow” or “pointy” openings.

Further, the shape of dispensing nozzles 164 may depend on the type of assay and/or reagent to be used. For example, different fluid viscosities may determine the preferred shape of dispensing nozzles 164. Further, certain reagents may include beads or other particles, which may require a certain spring force to dispense. Accordingly, certain assays and/or reagents may favor the “flared” or “wide” openings while a different assays and/or reagents may favor the “narrow” or “pointy” openings.

Further, FIG. 26 shows more details of seal 167 (e.g., a rubber gasket) sitting within seal channel 142 of top substrate 130 and seal interface 166 of reagent plate 150 applying pressure against seal 167. In this way, a seal may be affected for maintaining the liquid within the droplet operations region of DMF cartridge assembly 100.

Referring now to FIG. 28A through FIG. 28E is an example of a process of dispensing liquid from the DMF cartridge assembly 100 shown in FIG. 6 through FIG. 14 and including the reagent plate 150 for easily preparing, storing, stabilizing, transporting, and/or dispensing reagents. In this example, reagent actuators 194a through 194h are used to dispense reagent liquid 155 from reagent reservoirs 154a through 154h, respectively. Each of the reagent actuators 194 has an actuator rod 195. For example, actuator rods 195a through 195h provide linear drive to plungers 156 of reagent reservoirs 154a through 154h, respectively.

In DMF system 180, reagent actuators 194 are operated in a manner to provide slow controlled dispensing to avoid any over-pressure conditions that might cause oil or the droplet to shoot into the gap with too much force and interfere with neighboring wells, and to avoid bubbles. Generally, want to avoid causing any additional flow in the droplet operations gap.

Further, in DMF system 180, reagent actuators 194 may provide (1) a single linear drive to actuate all “rods” at the same time, (2) different spring-loaded plungers with different lengths, and spring-strength, and spring-lengths; and/or (3) different predefined reagent release timepoints.

In the example process shown in FIG. 28A through FIG. 28E, all actuator rods 195 are actuated at the same time. However, to provide different dispensing times, the actuator rods 195 may be of different lengths. In this example, the actuator rods 195g and 195h may be shorter in length than the actuator rods 195a through 195f. Accordingly, the time of dispense of reagent reservoirs 154g and 154h may be delayed compared with the time of dispense of reagent reservoirs 154a through 154f.

For example, FIG. 28A shows reagent reservoirs 154a through 154h filled with reagent liquid 155 and not yet dispensed.

Next, FIG. 28B shows reagent actuators 194a through 194h beginning to actuate. The longer actuator rods 195a through 195f come into contact with plungers 156 of reagent reservoirs 154a through 154f and reagent liquid 155 begins to dispense from reagent reservoirs 154a through 154f. By contrast, the shorter actuator rods 195g and 195h are not yet in contact with plungers 156 of reagent reservoirs 154g and 154h and therefore no reagent liquid 155 is dispensed from reagent reservoirs 154g and 154h.

Next, FIG. 28C shows reagent actuators 194a through 194h continue to actuate. Reagent liquid 155 continues to dispense from reagent reservoirs 154a through 154f. Further, the shorter actuator rods 195a through 195f now come into contact with plungers 156 of reagent reservoirs 154g and 154h and reagent liquid 155 begins to dispense from reagent reservoirs 154g and 154h. That is, reagent liquid 155 is now being dispensed from all reagent reservoirs 154a through 154h.

Next, FIG. 28D shows reagent actuators 194a through 194h continue to actuate. Reagent liquid 155 continues to dispense from reagent reservoirs 154a through 154f until the full dispense cycle is complete and reagent reservoirs 154a through 154f are empty. By contrast, reagent liquid 155 continues to dispense from reagent reservoirs 154g and 154h as the full dispense cycle is not yet complete.

Next, FIG. 28E shows reagent actuators 194g and 194h continue to actuate. Reagent liquid 155 continues to dispense from reagent reservoirs 154g and 154h until the full dispense cycle is complete and reagent reservoirs 154g and 154h are empty.

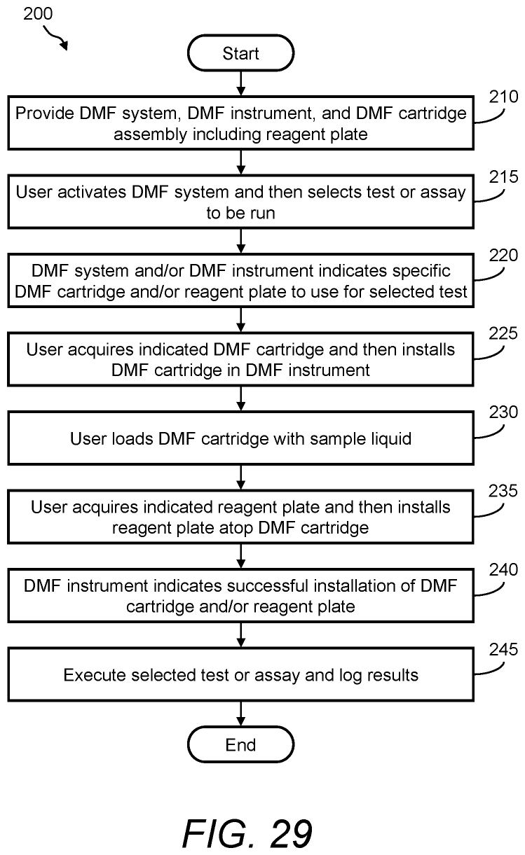

Referring now to FIG. 29 is a flow diagram of an example of a method 200 of using the presently disclosed DMF system 180, DMF instrument 185, and DMF cartridge assembly 100 including reagent plate 150 for easily preparing, storing, stabilizing, transporting, and/or dispensing reagents. In one example, method 200 may be used in a POC application, such as in a COVID-19 test POC application. Method 200 may include, but is not limited to, the following steps.

At a step 210, a DMF system, DMF instrument, and DMF cartridge assembly including a reagent plate is provided according to the invention. For example, the presently disclosed DMF system 180, DMF instrument 185, and DMF cartridge assembly 100 including DMF cartridge 105 and reagent plate 150 is provided, as described hereinabove with reference to FIG. 1 through FIG. 28.

At a step 215, a user activates the DMF system and then selects a test or assay to be run. For example, a user activates DMF system 180 and/or DMF instrument 185, and then uses the user interface thereof to select a test or assay to be run. In one example, the user selects a COVID-19 test to be run.

At a step 220, the DMF system and/or DMF instrument indicates the specific DMF cartridge and/or reagent plate to use for the selected test or assay. For example, DMF system 180 and/or DMF instrument 185 indicates the specific DMF cartridge 105 and/or reagent plate 150 to use for the selected test or assay. In one example, DMF system 180 and/or DMF instrument 185 indicates the specific DMF cartridge 105 and/or reagent plate 150 to use for a COVID-19 test.

At a step 225, the user acquires the indicated DMF cartridge and installs the DMF cartridge in the DMF instrument. For example, the user acquires the indicated DMF cartridge 105 and then installs the selected DMF cartridge 105 in DMF instrument 185. Further, the user may scan a barcode or QR code of the selected DMF cartridge 105 to ensure the proper selection. Alignment notch 118 of DMF cartridge 105 may be used to assist and guide the user with respect to the proper installation of DMF cartridge 105 into DMF instrument 185.

At a step 230, the user loads the DMF cartridge with sample liquid. For example, using a pipette, the user may load one or more of the sixteen sample reservoirs 132 of DMF cartridge 105 with sample liquid.

At a step 235, the user acquires the indicated reagent plate and then installs the reagent plate atop the DMF cartridge. For example, the user acquires the indicated reagent plate 150 and then installs the selected reagent plate 150 atop the DMF cartridge 105 in the DMF instrument 185. Further, the user may scan ID coding 162 (e.g., barcode or QR code) of the selected reagent plate 150 to ensure the proper selection. In this step, the user aligns the holding features 158 of reagent plate 150 with the snap pins 178 of DMF cartridge 105. Then, the user pushes down on the reagent plate 150 to engage the snap pins 178 into the openings 159 of the holding features 158 of the reagent plate 150. Further, in this step, a reliable seal is established (via seal 167) between reagent plate 150 and top substrate 130 of DMF cartridge 105.

At a step 240, the DMF instrument indicates the successful installation of the DMF cartridge and/or the reagent plate. For example, the DMF system 180 and/or DMF instrument 185 may perform certain verification steps and then indicate the successful installation of the DMF cartridge 105 and/or reagent plate 150 in DMF instrument 185.

At a step 245, the selected test or assay is executed and then the test results are logged. For example, using the presently disclosed DMF system 180, DMF instrument 185, and DMF cartridge assembly 100 including DMF cartridge 105 and reagent plate 150, the user initiates the selected test or assay to run, such as a COVID-19 test. Then, after some period of time, the test results (e.g., COVID-19 test results) may be displayed to the user and also stored at DMF system 180.

In summary and referring now again to FIG. 1 through FIG. 29, the presently disclosed DMF system 180, DMF instrument 185, DMF cartridge assembly 100, and method 200 may provide DMF cartridge assembly 100 including DMF cartridge 105 and reagent plate 150 and wherein DMF cartridge 105 may include bottom substrate 110 and top substrate 130 and wherein reagent plate 150 may be provided separately from DMF cartridge 105.

In some embodiments, the presently disclosed DMF system 180, DMF instrument 185, DMF cartridge assembly 100, and method 200 may provide DMF cartridge assembly 100 including DMF cartridge 105 and reagent plate 150 and wherein reagent plate 150 may include a set of reagent reservoirs 154 and wherein the number, configurations, and volumes of the reagent reservoirs 154 may vary.

In some embodiments, the presently disclosed DMF system 180, DMF instrument 185, DMF cartridge assembly 100, and method 200 may provide DMF cartridge assembly 100 including DMF cartridge 105 and reagent plate 150 and wherein reagent plate 150 may include a set of reagent reservoirs 154 that may be dispensed via reagent (linear) actuators 194 coupled to plungers 156 of the reagent reservoirs 154.

In some embodiments, the presently disclosed DMF system 180, DMF instrument 185, DMF cartridge assembly 100, and method 200 including reagent plate 150 may provide an easy and safe means for handling a predefined set of reagents and volumes and in a manner that may be automated, low cost, safe, and supporting easy-to-use POC testing devices.

Further, method 200 is provided for using the presently disclosed DMF system 180, DMF instrument 185, and DMF cartridge assembly 100 including reagent plate 150 for easily preparing, storing, stabilizing, transporting, and/or dispensing reagents.

While preferred embodiments of the present disclosure have been shown and described herein, it will be obvious to those skilled in the art that such embodiments are provided by way of example only. It is not intended that the invention be limited by the specific examples provided within the specification. While embodiments of the present disclosure have been described with reference to the aforementioned figures and detailed description, the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the invention. It is therefore contemplated that this disclosure shall also cover any such alternatives, modifications, variations or equivalents. It is intended that the following claims define the scope of the invention and that methods and structures within the scope of these claims and their equivalents be covered thereby.

1. A reagent plate for use with a digital microfluidics (“DMF”) cartridge, the reagent plate comprising:
one or more holding features for coupling the reagent plate to a top substrate of a DMF cartridge;
one or more reagent reservoirs configured to contain a reagent therein, the one or more reagent reservoirs each comprising a dispensing nozzle; and
one or more reagent actuators configured to cause the reagent to be dispensed from the one or more reagent reservoirs through the dispensing nozzle and into a droplet operations region of the DMF cartridge.

2. The reagent plate of claim 1, wherein the shape of the dispensing nozzle is selected based on the reagent used or an assay to be performed using the DMF cartridge.

3. The reagent plate of claim 1, wherein the dispensing nozzle is configured to dispense the reagent above, at, or below an oil level of the droplet operations region.

4. The reagent plate of claim 1, wherein each of the one or more reagent actuators comprises an actuator rod for depressing a plunger disposed within an opening of the one or more reagent reservoirs.

5. The reagent plate of claim 4, wherein the length of the actuator rod is selected based on a desired dispensing time.

6. The reagent plate of claim 1, wherein the reagent plate further comprises one or more pressure features for providing a proper gap height to a droplet operations gap of the DMF cartridge.

7. The reagent plate of claim 6, wherein the pressure features are mechanical structures that enable a force to transfer from a center portion of the reagent plate to the top substrate of the DMF cartridge.

8. The reagent plate of claim 1, where in the reagent plate further comprises a seal interface for positioning a seal between the reagent plate and the DMF cartridge for maintaining a liquid within the droplet operations region of the DMF cartridge.

9. The reagent plate of claim 8, wherein the seal is selected from a gasket, an arrangement of support ribs, and combinations thereof.

10. The reagent plate of claim 1, further comprising one or more alignment features for reducing an alignment error between the reagent plate and the DMF cartridge.

11. The reagent plate of claim 10, wherein the one or more alignment features is a visual marker.

12. The reagent plate of claim 10, wherein the one or more alignment features is an ID code.

13. The reagent plate of claim 12, wherein the ID code is a bar code or QR code.

14. The reagent plate of claim 12, wherein the ID code is further configured to allow for the identification of the reagent plate to ensure the proper reagent plate is used from a certain test or assay to be performed using the DMF cartridge.

15. The reagent plate of claim 1, wherein each of the one or more reservoirs may be sealed using a reservoir cap for storing the reagent.

16-27. (canceled)
